(19) United States
(12) Patent Application Publication
(10) Pub. No.: US 2015/0159571 A1
(43) Pub. Date: Jun. 11, 2015

(54) METHOD OF CONTROLLING ENGINE SPEED

(71) Applicant: Caterpillar Inc., Peoria, IL (US)

(72) Inventors: Srikar Thaduvayi, Peoria, IL (US); Alexander C. Crosman, Dunlap, IL (US)

(73) Assignee: Caterpillar Inc., Peoria, IL (US)

(21) Appl. No.: 14/101,401

(22) Filed: Dec. 10, 2013

(51) Int. Cl. F02D 41/00

(52) U.S. Cl. CPC F02D 41/0097

(57) ABSTRACT

A method of controlling an engine speed of a machine is provided. The method includes determining if an engine power demand is below a rated engine power. The method further includes determining if a drive motor of the machine is operating within a constant power region. The method also includes comparing an available engine power with the engine power demand. The method further includes changing the engine speed such that an available engine power is greater than the engine power demand by a predetermined margin.

### TECHNICAL FIELD

The present disclosure relates to an engine, and more particularly to a method of controlling an engine speed.

### BACKGROUND

Machines, such as off-highway trucks and on-highway trucks, are well known in the art. Such machines include an engine for generating power. Further, in such machines, a turbocharger provides air to the engine in order to increase a power output. The power output of the engine generally varies with engine speed.

The engine is typically provided with a minimum engine speed while the machine is being driven. The minimum engine speed is set in order to prevent surging in the turbochargers and to enable improved acceleration from rest. However, operating the engine at the minimum engine speed, during partial load conditions, may reduce a fuel efficiency of the engine.

### SUMMARY

In one aspect of the disclosure, a method of controlling an engine speed of a machine is provided. The method includes determining if an engine power demand is below a rated engine power. The method further includes determining if a drive motor of the machine is operating within a constant power region. The method also includes comparing an available engine power with the engine power demand. The method further includes changing the engine speed such that an available engine power is greater than the engine power demand by a predetermined margin

Other features and aspects of this disclosure will be apparent from the following description and the accompanying drawings.

### BRIEF DESCRIPTION OF THE DRAWINGS

FIG. 1 illustrates a side view of an machine having a drive system, according to an embodiment of the present disclosure;

FIG. 2 illustrates a schematic view of the drive system of the machine, according to an embodiment of the present disclosure;

FIG. 3 illustrates a plot of engine power versus engine speed, according to an embodiment of the present disclosure;

FIG. 4 illustrates a plot of engine speed versus time, according to an embodiment of the present disclosure;

FIG. 5 illustrates a plot of engine power versus time, according to an embodiment of the present disclosure; and

FIG. 6 illustrates a flowchart depicting a method of controlling engine speed, according to an embodiment of the present disclosure.

### DETAILED DESCRIPTION

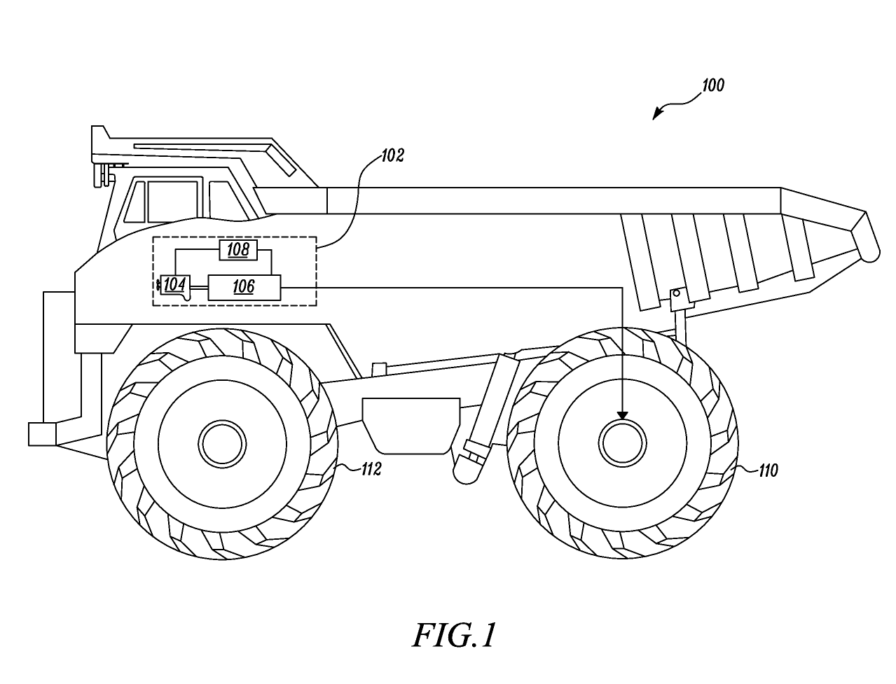

The present disclosure relates to a method of controlling an engine speed of a machine. The present disclosure will now be described in detail with reference being made to accompanying figures. FIG. 1 illustrates an exemplary machine 100, according to an embodiment of the present disclosure. The machine 100 is exemplified as an off-highway truck that may be used in construction, mining, quarrying, or any other type of industry that requires heavy machinery. However, in various other embodiments, the machine 100 may be any other type of machine, for example, articulated trucks, on-highway trucks, and the like.

The machine 100 includes a drive system 102 which may be used for propulsion of the machine 100, and for operating various other components (E.g., fans, pumps etc.) of the machine 100. The drive system 102 includes an engine 104, an electric unit 106, an electronic control module (ECM) 108, and drive wheels 110. The drive wheels 110 may be rear wheels and provide traction to the machine 100. Alternatively, the front wheels 112 along with the drive wheels 110 may provide traction to the machine 100. Further, it may be contemplated that tracks (not shown) may be used instead of the drive wheels 110 for traction. Further, the engine 104 may be any type of internal combustion engine which produces mechanical power. For example, the engine 104 may be a gasoline, a diesel, a gaseous fuel, or a dual fuel engine. In an embodiment, a turbocharger (not shown) may provide air to the engine 104.

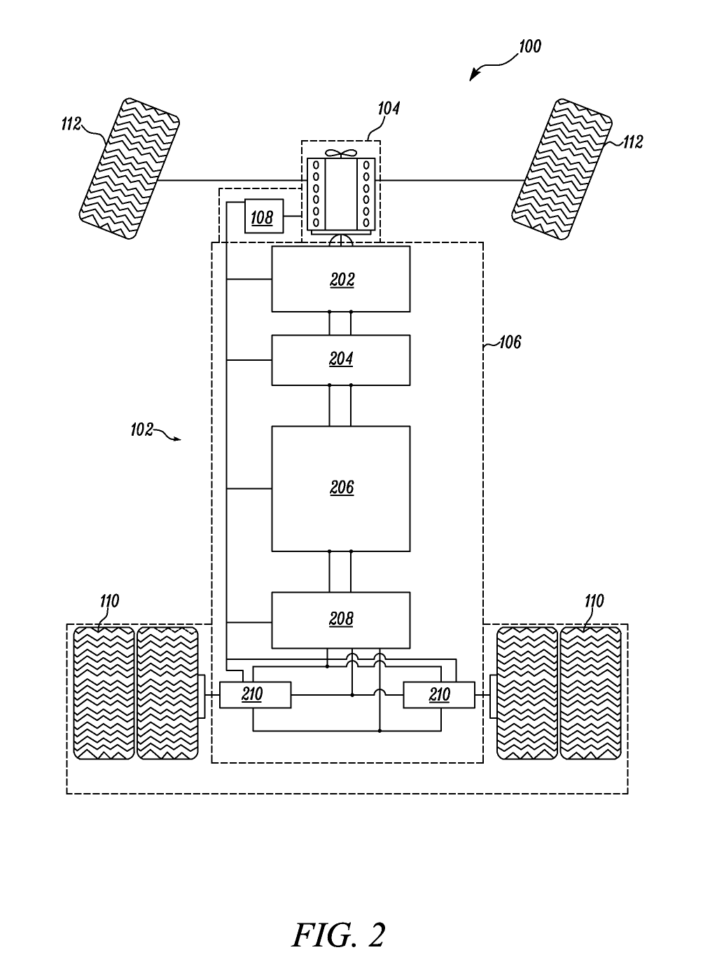

FIG. 2 illustrates a schematic view of the drive system 102, according to an embodiment of the present disclosure. As illustrated in FIG. 2, the electric unit 106 includes a generator 202, a rectifier 204, a DC link 206, an inverter 208 and drive motors 210. The engine 104 may be mechanically coupled to the generator 202. The generator 202 may convert the mechanical power from the engine 104 into electric power. Further, the generator 202 may produce electric power in the form of AC power.

The rectifier 204 may be electrically coupled to the generator 202. The rectifier 204 may convert the AC power produced by the generator 202 into DC power. The DC link 206 may electrically connect the rectifier 204 to the inverter 208. The DC link 206 may provide a smoothed DC power to the inverter 208. The inverter 208 may convert the DC power received from the DC link 206 into AC power. Further, the inverter 208 may provide the drive motors 210 with AC power. The inverter 208 may further control a speed and/or torque of the drive motors 210 by regulating a frequency and/or pulse width of the AC power. The drive motors 210 may be mechanically coupled to the drive wheels 110 which provide traction. Therefore, the drive motors 210 may provide mechanical power to the drive wheels 110 in order to propel the machine 100. The drive motors 210 may also power other components of the machine 100 in addition to the drive wheels 110.

In an embodiment, each of the drive motors 210 may operate in at least one of two regions: a constant torque region and a constant power region. The constant torque region may be the region in which a drive capability of each of the drive motors 210 is the limiting factor. In the constant torque region, the torque, generated by each of the drive motors 210, may be limited due to a motor rating or other limitations in a drivetrain connected to the drive motors 210, such as available friction between the drive wheels 110 and a ground surface. In contrast, the constant power region may be the region in which the engine 104 is the limiting factor. The constant power region may optimize a utilization of the mechanical power produced by the engine 104. Therefore, the drive system 102 may be configured such that operation of each of the drive motors 210 in the constant power region may be maximized. Further, each of the drive motors 210 may produce a substantially constant torque over a speed range in the constant torque region and transitions to the constant power region when a threshold speed of each of the drive motors 210 is reached. The threshold speed may be lower than a normal operating speed of each of the drive motors 210. In the constant power region, each of the drive motors 210 may generate a substantially constant power or a rated power.

Various details of the drive system 102, as explained above, are purely exemplary in nature. It may be contemplated that the drive system 102 includes a hydraulic unit (not shown) having multiple hydraulic drive motors and pumps. The engine 104 may then provide power to the hydraulic unit. Further, the hydraulic drive motors may provide power to the drive wheels 110.

Referring to FIGS. 1 and 2, the ECM 108 may be configured to receive input signals corresponding to various parameters of the machine 100. For example, the ECM 108 may receive input signals corresponding to an engine torque, an engine speed, fuel consumption, a power measured at the DC link 206, various parameters (speed, torque, power) of the drive motors 210, operator inputs, and loads of various components of the machine 100. The ECM 108 may compute an engine power demand based on the various input signals. The ECM 108 may also control various parameters of the engine 104, such as, the engine speed and/or engine torque based on the input signals. The ECM 108 may further control the inverter 208 to regulate the frequency and/or pulse width of the AC power. The ECM 108 may include stored plots, tables, algorithms etc., in order to implement various control strategies.

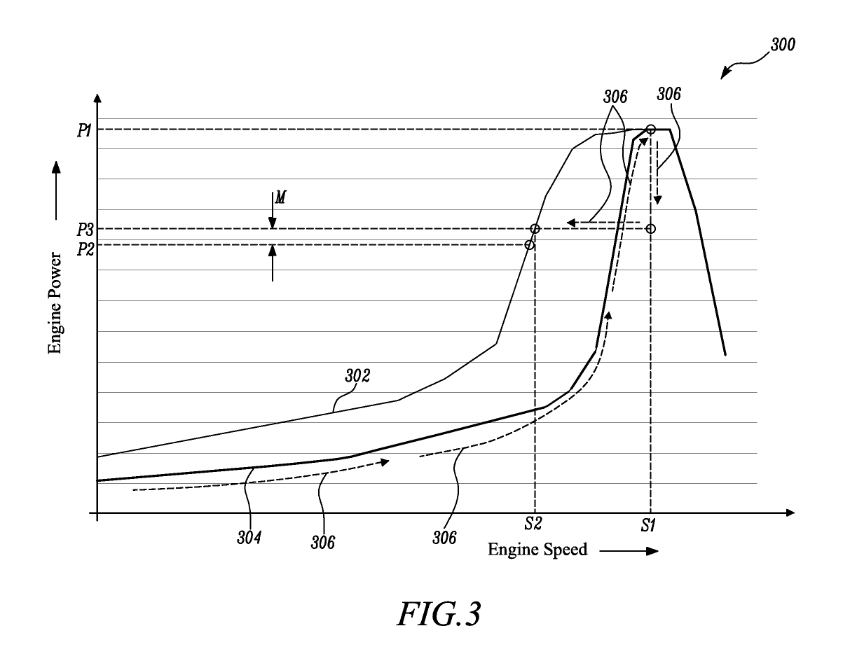

FIG. 3 illustrates an exemplary plot 300 of engine power versus engine speed, according to an embodiment of the present disclosure. The plot 300 may be stored in the ECM 108, and may be used to control various parameters of the drive system 102. The plot 300 includes a continuous power curve 302 and an acceleration power curve 304. The continuous power curve 302 may represent a maximum engine power that can be generated by the engine 104, for a given engine speed, during a continuous operation of the engine 104. The rated engine power P1 of the engine 104 may be the highest power on the power curve 302. A rated engine speed S1 may correspond to the rated engine power P1. The acceleration power curve 304 may represent a path followed during acceleration of the engine 104 when an engine power demand is significantly higher than an available engine power. In an embodiment, the available engine power may be a power measured at the DC link 206. As illustrated by the arrows 306 in FIG. 3, the ECM 108 may regulate the engine 104 to follow the acceleration power curve 304 to the rated engine power P1 from a low speed, when an engine power demand is high. The rated engine power P1 may correspond to a full load operation of the machine 100. In an embodiment, the ECM 108 may control the engine speed based on the engine power demand.

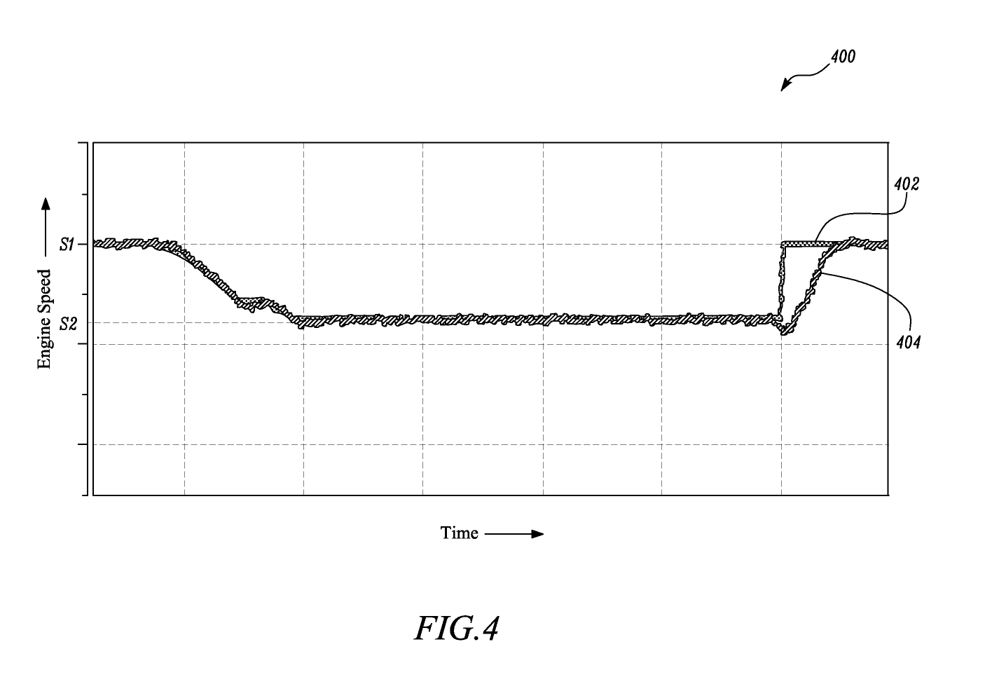

FIG. 4 illustrates an exemplary plot 400 of engine speed versus time, according to an embodiment of the present disclosure. The variation in FIG. 4 may be after the engine 104 has reached the rated engine power P1. A curve 402 may represent a variation of a required engine speed with time. Further, a curve 404 may represent a variation of the engine speed with time.

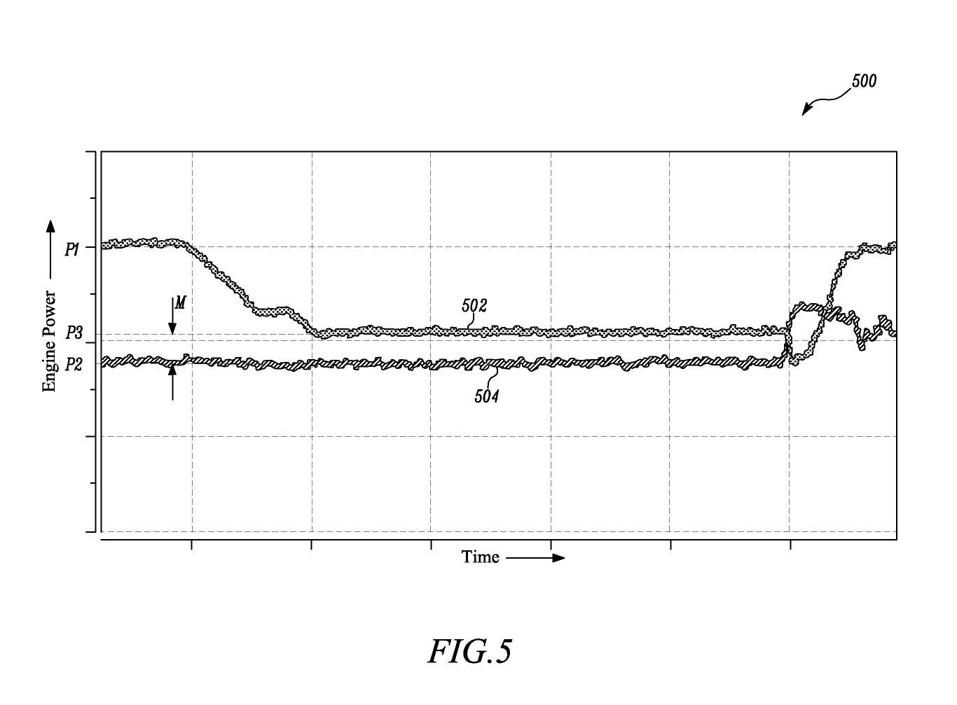

FIG. 5 illustrates an exemplary plot 500 of engine power versus time, according to an embodiment of the present disclosure. The variation in FIG. 5 may be after the engine 104 has reached the rated engine power P1. A curve 502 may represent a variation of the available engine power with time. Further, the curve 504 may represent a variation of the engine power demand with time.

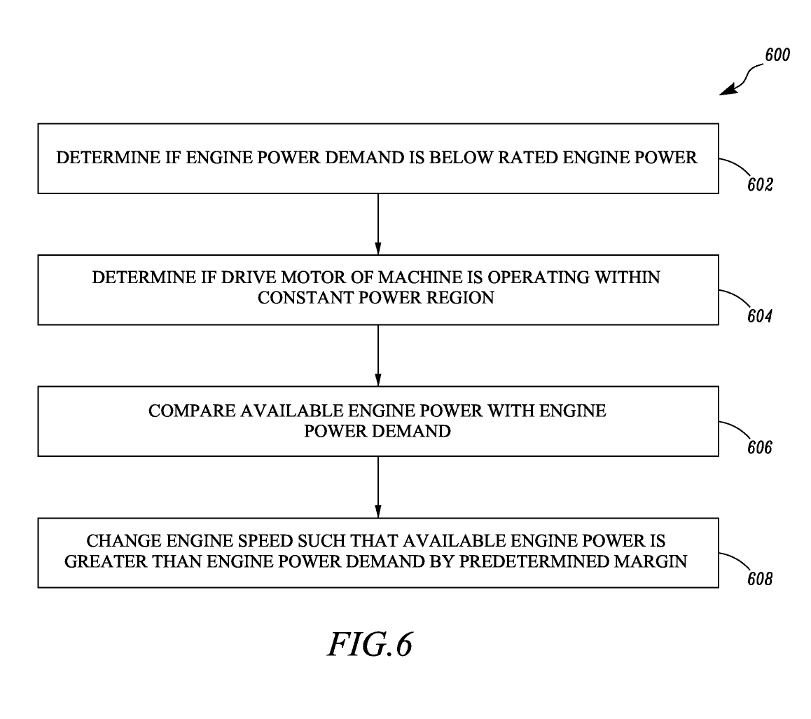

FIG. 6 illustrates a method 600 of controlling the engine speed, according to an embodiment of the present disclosure. The plots 400 and 500 may represent the ECM 108 controlling the engine speed based on the method 600.

Referring to FIGS. 2-6, at step 602 of the method 600, the ECM 108 may determine if the engine power demand is below the rated engine power P1. In an embodiment, the ECM 108 may determine the engine power demand by a current engine torque, the power at the DC link 206, and the loads of various components of the machine 100. After calculating the engine power demand, the ECM 108, for example, may determine that the engine power demand has fallen to P2 (shown in FIGS. 3 and 5) from the rated engine power P1. The engine power demand of P2 may correspond to a part load operation of the machine 100.

At step 604, the ECM 108 may determine if each of the drive motors 210 of the machine 100 are operating in the constant power region. This may ensure that the drive motors 210 are generating the constant power or the rated power. Therefore, the machine 100 may be in a forward or reverse drive when the drive motors 210 are operating in the constant power region.

At step 606, the ECM 108 may compare an available engine power (the rated engine power P1 in this case) with the engine power demand of P2. At step 608, the ECM 108 may decrease the engine speed to a required engine speed of S2. The decrease in the engine speed is shown by the arrows 306 in FIG. 3. The decrease in the engine speed from the rated engine speed S1 to the engine speed of S2 is also shown in FIG. 4. In an embodiment, an available engine power of P3, corresponding to the engine speed of S2, may be greater than a predetermined margin (illustrated as M in FIGS. 3 and 5) above the engine power demand of P2. In various embodiments, the predetermined margin may be a predetermined fixed value, or a value based on a predetermined percentage of the engine power demand. The predetermined margin may vary for different types of machines and/or engines. In a further embodiment, as shown in FIG. 4, the engine speed may be reduced gradually in discrete steps. Consequently, as shown in FIG. 5, the available engine power may also reduce gradually in discrete steps.

As illustrated in FIG. 5, after an interval of time, the engine power demand may increase. Consequently, as illustrated in FIG. 4, the required engine speed may increase to the rated engine speed S1. The ECM 108 may now increase the engine speed to the rated engine speed S1 such that the available engine power may be equal to the rated engine power P1. The rated engine power P1 may be higher than the engine power demand by the predetermined margin.

Thus, the ECM 108 may continuously compare the engine power demand with the available engine power, and may decrease or increase the engine speed such that the available engine power may be higher than the engine power demand by the predetermined margin.

### INDUSTRIAL APPLICABILITY

The present disclosure is related to the method 600 of controlling an engine speed of the machine 100. The method 600 may be applicable to the machine 100 including the engine 104 as part of the drive system 102. The machine may be, for example, but not limited to, an off-highway truck, an on-highway truck, an articulated truck, and the like.

The method 600 may include determining if the engine power demand is below the rated engine power P1. The method 600 may further include determining if each of the drive motors 210 of the machine 100 are operating in the constant power region. The method 600 may include comparing the engine power demand with the available engine power. The method 600 may include changing the engine speed such that the available engine power may be higher than the engine power demand by the predetermined margin.

The method 600 may enable the engine 104 to operate at a lower engine speed when the engine 104 is in a partial load operation. For example, the engine speed may be reduced from the rated engine speed S1 to the engine speed of S2, when the engine power demand reduces from the rated engine power P1 to the engine power demand of P2. Operating at a lower engine speed, during a partial load operation of the engine 104, may improve fuel economy, and reduce sound levels of the engine 104. Further, a life of various components may be increased. Moreover, an operator comfort level may be improved.

The method 600 may change the engine speed such that the available engine power is higher than the engine power demand by the predetermined margin. The predetermined margin may allow for minor deviations in the engine power demand Further, the predetermined margin may also help the engine 104 to accelerate rapidly to the rated engine speed S1, when there is a significant increase in the engine power demand. Further, since the engine speed is changed when the drive motors 210 are operating in the constant power region, the engine speed reduction may be limited so as to prevent surging in the turbocharger.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of controlling an engine speed of a machine, the method comprising:
determining if an engine power demand is below a rated engine power;
determining if a drive motor of the machine is operating within a constant power region;
comparing an available engine power with the engine power demand; and
changing the engine speed such that an available engine power is greater than the engine power demand by a predetermined margin.
